(19) United States
(12) Patent Application Publication
(10) Pub. No.: US 2020/0169809 A1
(43) Pub. Date: May 28, 2020

(54) WEARABLE BEAMFORMING SPEAKER ARRAY

(71) Applicant: HARMAN INTERNATIONAL INDUSTRIES, INCORPORATED, Stamford, CT (US)

(72) Inventors: Adam BOULANGER, Palo Alto, CA (US); Stefan MARTI, Oakland, CA (US); Joseph VERBEKE, San Francisco, CA (US); Davide DI CENSO, Sunnyvale, CA (US)

(21) Appl. No.: 16/203,537

(22) Filed: Nov. 28, 2018

(51) Int. Cl. H04R 3/12; H04R 5/04; H04R 5/02

(52) U.S. Cl. CPC H04R 3/12; H04R 5/04; H04R 2203/12; H04R 2430/20; H04R 5/02

(57) ABSTRACT

Embodiments of the present disclosure set forth a system comprising a speaker array, one or more sensors configured to produce sensor data, and a processor coupled to the one or more sensors and the speaker array. The processor is configured to determine, based on the sensor data, for each speaker included in the speaker array, a position of the speaker relative to at least one of a target location, and one or more other speakers included in the speaker array, determine, based on the positions of the speakers included in the speaker array, a first set of directional sound components. The processor is further configured to generate a first set of speaker signals for the speaker array based on the first set of directional sound components, where, when outputted by the speaker array, the first set of speaker signals produces an acoustic field at the target location.

### BACKGROUND

### Field of the Various Embodiments

Embodiments of the present disclosure relate generally to audio systems and, more specifically, to a wearable beamforming speaker array.

### Description of the Related Art

Consumer electronics devices, such as smartphones, media players, tablet computers, personal computers, virtual reality (VR) devices, and/or augmented reality (AR) devices, enable users to enjoy media content in various environments and while performing a variety of different activities. Such devices commonly have an audio output device that includes one or more audio transducers. The audio transducers emit soundwaves reproducing an audio signal that represents the audio portion of the media content. When the soundwave reaches the ears of the user, the user is able to hear the audio portion of the media content.

In some devices, the audio transducers output sound into the surrounding environment, such that the sound can be heard by others proximate to the user. Alternatively, if the user wishes to listen to the audio portion of the media content more privately and/or does not want to disturb others in the surrounding environment, then the user may listen to the audio portion via a pair of headphones, where the audio transducers output sound towards the user's ears without outputting sound into the environment.

Although headphones generally allow a user to listen to high-quality audio content privately and/or without disturbing others, such devices have several downsides. For example, when headphones are worn by a user, the headphones may occlude the user's ears, preventing the user from hearing other sounds in the environment. In addition, headphones may move out of position while a user is moving, preventing the user from hearing the audio content and/or requiring the user to repeatedly reposition the headphones. For example, while a user is exercising or performing other activities that involve movement, on-ear or over-the-ear headphones may move relative to the head of the user, and in-ear headphones may fall out of the user's ear canal.

As the foregoing illustrates, improved techniques for outputting audio content to a user would be useful.

### SUMMARY

Embodiments of the present disclosure set forth an audio system including a speaker array including two or more speakers, one or more sensors configured to produce sensor data, and a processor coupled to the one or more sensors and the speaker array. The processor is configured to determine, based on the sensor data, for each speaker included in the speaker array, a position of the speaker relative to at least one of a target location, and one or more other speakers included in the speaker array, determine, based on the positions of the speakers included in the speaker array, a first set of directional sound components. Each directional sound component included in the first set of directional sound components is defined between a corresponding speaker and the target location. The processor is further configured to generate a first set of speaker signals for the speaker array based on the first set of directional sound components, where, when outputted by the speaker array, the first set of speaker signals produces an acoustic field at the target location.

Further embodiments provide, among other things, a method and computer-readable storage medium for implementing aspects of the methods set forth above.

At least one advantage of the disclosed techniques is that an audio portion of media content can be provided to a user without requiring the user to wear headphones that obstruct other sounds in the surrounding environment from reaching the user. In addition, a composite acoustic field can be generated in a variety of different spatial configurations, despite changes to the position(s) and/or orientation(s) of individual speakers included in the speaker array. This adaptability of the beamforming speaker array system enables greater design flexibility, allowing the system to be implemented in a variety of different form factors.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1A illustrates a block diagram of a beamforming speaker array system configured to implement one or more aspects of the present disclosure.

FIG. 1B illustrates a technique for processing sensor data and audio data via the spatial computation application of FIG. 1A to output audio content, according to various embodiments of the present disclosure.

FIG. 2 illustrates the beamforming speaker array system of FIG. 1A in a wearable device form factor, according to various embodiments of the present disclosure.

FIG. 3 illustrates a configuration of the beamforming speaker array system of FIG. 1A and directional sound components emitted by the speakers towards a target, according to various embodiment of the present disclosure.

FIG. 4 illustrates the beamforming speaker array system of FIG. 1A in a wearable device form factor that includes position sensors, according to various embodiments of the present disclosure.

FIG. 5 illustrates a speaker included in the beamforming speaker array system of FIG. 1A emitting soundwaves at different positions, according to various embodiments of the present disclosure.

FIG. 6 illustrates a predictive estimation of a position of a speaker included in the beamforming speaker array system of FIG. 1A as a user moves, according to various embodiments of the present disclosure.

FIGS. 7A-7B illustrate a different technique to estimate the position of an individual speaker included in the beamforming speaker array system of FIG. 1B, according to various embodiments of the present disclosure.

FIG. 8 is a flow diagram of method steps for generating speaker signals to emit directional sounds, according to various embodiments of the present disclosure.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

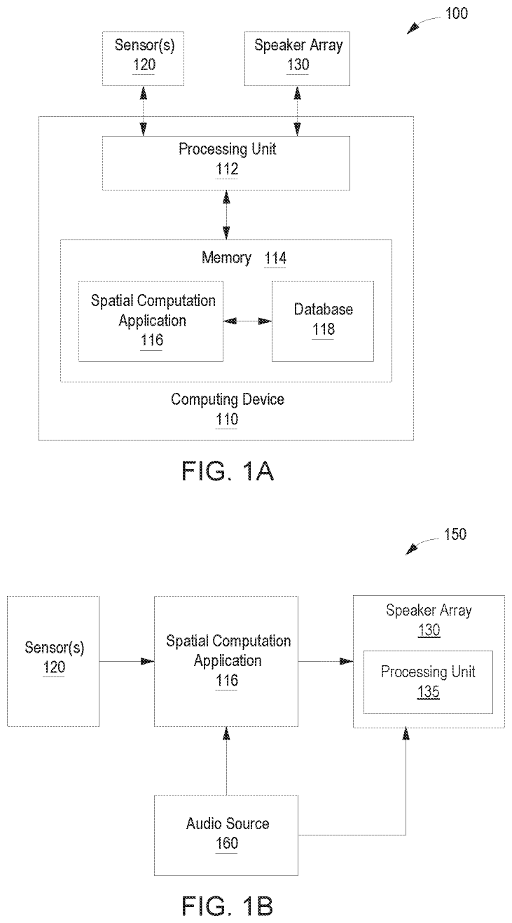

FIG. 1A illustrates a block diagram of a beamforming speaker array system 100 configured to implement one or more aspects of the present disclosure. Beamforming speaker array system 100 includes computing device 110, one or more sensors 120, and speaker array 130. Computing device 110 includes processing unit 112 and memory 114. Memory 114 stores spatial computation application 116 and database 118.

In operation, processing unit 112 receives sensor data from sensor(s) 120. Processing unit 112 executes spatial computation application 116 to analyze the sensor data and determine the current configuration of speaker array 130, including the positions and/or orientations of the individual speakers included in speaker array 130. Upon determining the current configuration of speaker array 130, spatial computation application 116 determines directional sound components from which speaker signals are to be emitted by each speaker included in the speaker array 130. The speaker signals produce a particular acoustic field at a target location, such as proximate to the ears of a user.

Once the spatial computation application 116 determines directional sound components, spatial computation application 116 may then generate one or more sound parameters for each speaker in the speaker array 130. Spatial computation application 116 then generates one or more speaker signals based on the one or more sound parameters and based on an audio source signal. The speaker signals may then be transmitted to the speakers included in the speaker array 130, which receive the speaker signals and output sound based on the speaker signals. The sound outputted by the speakers (e.g., a speaker and an amplifier) included in speaker array 130 then combines to produce a composite acoustic field at the target location. In some embodiments, the target location includes the ears of a user, enabling the user to listen to a high-quality, composite acoustic field via multiple speakers that are located proximate to the user.

In some embodiments, the one or more sound parameters may include, without limitation, a direction in which a target is located relative to a speaker (e.g., relative to a center axis of a speaker), a sound level to be outputted by a speaker in order to generate a desired sound level at a target location (e.g., a target location that is off-axis relative to a speaker), a distance between a speaker and a target location, a distance and/or angle between the speaker and one or more other speakers included in the speaker array 130, a phase delay to be applied to a speaker signal in order to generate a desired acoustic field at a target location, etc. For example, the spatial computation application 116 could determine one or more sound parameters that include an angular direction of a target location relative to a center axis of the speaker. The spatial computation application 116 could then determine, based on the one or more sound parameters, a sound level that should be outputted by the speaker in order to generate a desired sound level at the target location.

Sensor(s) 120 include one or more devices that detect positions of objects in an environment by performing measurements and/or collecting data. In some embodiments, the one or more sensors 120 may be coupled to and/or included within individual speakers included in speaker array 130. In such instances, computing device 110 may receive sensor data via the one or more sensors 120, where the sensor data reflects the position(s) and/or orientation(s) of one or more speakers included in speaker array 130. The position(s) and/or orientation(s) of the one or more speakers may be derived from the absolute position of the one or more sensors 120, or may be derived from a relative position of an object to the one or more sensors 120. Processing unit 112 then executes spatial computation application 116 to analyze the received sensor data to determine a current configuration of speaker array 130, including the position(s) and/or the orientation(s) of the one or more speakers.

In some embodiments, sensor(s) 120 may produce sensor data that is associated with the positions of portions of the user's body. For example, sensor(s) 120 may be positioned near one or more ears of the user and may produce sensor data. Processing unit 112 may analyze the sensor data to track the location of one of the user's ears, both of the user's ears, and/or the user's head based on the sensor data. The spatial computation application 116 may then determine a target location at which an acoustic field will be generated based on the location(s).

In various embodiments, the one or sensors 120 may include position sensors, such as an accelerometer or an inertial measurement unit (IMU). The IMU may be a device like a three-axis accelerometer, gyroscopic sensor, and/or magnetometer. In some embodiments, sensor(s) 120 may include optical sensors, such RGB cameras, time-of-flight sensors, infrared (IR) cameras, depth cameras, and/or a quick response (QR) code tracking system. In addition, in some embodiments, sensor(s) 120 may include wireless sensors, including radio frequency (RF) sensors (e.g., sonar and radar), ultrasound-based sensors, capacitive sensors, laser-based sensors, and/or wireless communications protocols, including Bluetooth, Bluetooth low energy (BLE), wireless local area network (WiFi) cellular protocols, and/or near-field communications (NFC).

As noted above, computing device 110 may include processing unit 112 and memory 114. Computing device 110 may be a device that includes one or more processing units 112, such as a system-on-a-chip (SoC), or a mobile computing device, such as a tablet computer, mobile phone, media player, and so forth. In some embodiments, computing device 110 is integrated with an individual speaker included in speaker array 130. Generally, computing device 110 may be configured to coordinate the overall operation of beamforming speaker array system 100. In some embodiments, computing device 110 may be coupled to, but be separate from, one or more individual speakers included in speaker array 130. In such instances, computing device 110 may be included in a separate device. The embodiments disclosed herein contemplate any technically-feasible system configured to implement the functionality of beamforming speaker array system 100 via computing device 110.

Processing unit 112 may include a central processing unit (CPU), a digital signal processing unit (DSP), a microprocessor, an application-specific integrated circuit (ASIC), a neural processing unit (NPU), a graphics processing unit (GPU), a field-programmable gate array (FPGA), and so forth. In some embodiments, processing unit 112 may be configured to execute spatial computation application 116 in order to analyze sensor data acquired by sensor(s) 120 and determine a current configuration of speaker array 130. In some embodiments, processing unit 112 may be configured to execute spatial computation application 116 to compute one or more directional sound components, where the one or more directional sound components are based on the determined current configuration of speaker array 130. Processing unit 112 is configured to execute spatial computation application 116 to generate one or more sound parameters based on the directional sound components. The one or more sound parameters include one or more parameters that cause the speaker array 130 to emit soundwaves based on the sound parameters. In some embodiments, processing unit 112 is configured to generate speaker signals from the one or more sound parameters and then transmit the speaker signals to speaker array 130. In some embodiments, processing unit 112 transmits the speaker signals to one or more speakers in speaker array 130 wirelessly.

In various embodiments, processing unit 112 executes spatial computation application 116 in order to determine sound parameters and generate speaker signals for all speakers included in the speaker array 130. Alternatively, in some embodiments, each speaker included in speaker array 130 may include a separate processing unit that determines one or more sound parameters for that speaker and/or generates a speaker signal to be outputted by that speaker, based on the one or more sound parameters. In such instances, each speaker may include a processing unit that executes an instance of the spatial computation application 116 in order to generate a single speaker signal for a single speaker. In some embodiments, each spatial computation application 116 may also determine the current configuration of the speaker array 130 and determine one or more sound parameters for that speaker based on the configuration of the speaker array 130.

Additionally, in some embodiments, processing unit 112 could execute spatial computation application 116 to determine one or more sound parameters for each speaker. The sound parameter(s) could then be transmitted to each speaker, and a processing unit included in each speaker could generate and output a speaker signal based on the sound parameter(s). Accordingly, although various embodiments disclosed herein are described as being performed via a processing unit 112 that executes spatial computation application 116, each of the disclosed techniques could be performed by separate processing units included in individual speakers.

Memory 114 may include a memory module or collection of memory modules. Spatial computation application 116 within memory 114 may be executed by processing unit 112 to implement the overall functionality of the computing device 110 and, thus, to coordinate the operation of the beamforming speaker array system 100 as a whole.

Database 118 may store values and other data retrieved by processing unit 112 to coordinate the operation of beamforming speaker array system 100. During operation, processing unit 112 may be configured to store values in database 118 and/or retrieve values stored in database 118. For example, database 118 may store sensor data, predictive estimation values, audio content, digital signal processing algorithms, transducer parameter data, and so forth.

During operation, the configuration of speaker array 130 may change. The change in the updated configuration of speaker array 130 may be due to a change in position(s) and/or orientation(s) of one or more individual speakers. In such instances, speaker array 130 may receive updated sound parameters generated by spatial computation application 116, where the updated sound parameters account for the updated configuration. Speaker array 130 may then emit soundwaves based on the updated sound parameters in order to continue to produce a composite acoustic field at the target location. Accordingly, speaker array 130 may be configured to consistently produce the composite acoustic field at the target location, even as the configuration of speaker array 130 changes.

FIG. 1B illustrates a technique for processing sensor data and audio data via the spatial computation application 116 of FIG. 1A to output audio content, according to various embodiments of the present disclosure. In some embodiments of block diagram 150, one or more speakers included in speaker array 130 includes a processing unit 135. In various embodiments, processing unit 135 may include one or more digital signal processors (DSPs). In other embodiments, none of the individual speakers included in speaker array 130 include a processing unit 135. In such instances, processing unit 112 included in computing device 100 may execute one or more digital signal processing algorithms that would otherwise be performed by processing unit 135.

During operation, sensor(s) 120 transmit sensor data to spatial computation application 116. Spatial computation application 116 analyzes the sensor data to determine the current configuration of speaker array 130. In various embodiments, the current configuration of speaker array 130 includes the position(s) and/or orientation(s) of individual speakers. In various embodiments, the position(s) and/or orientation(s) may be based on absolute positions within an environment. In other embodiments, the position(s) and/or orientation(s) may be relative to the other individual speakers included in speaker array 130. For example, the current configuration of speaker array 130 includes the position(s) and/or orientation(s) of individual speakers relative to a target location and/or relative to one or more other devices (e.g., the ears of the user, computing device 110, audio source 120, and so forth). Upon determining the current configuration of speaker array 130, spatial computation application 116 computes a set of directional sound components that are to be part of acoustic fields produced by a set of soundwaves to be emitted by speaker array 130.

Audio source 160 generates one or more audio source signals to be delivered to at least one of spatial computation application 116 and/or speaker array 130. In general, audio source 160 may include any type of audio device, such as a personal media player, a smartphone, a portable computer, a television, etc. In some embodiments, spatial computation application 116 receives one or more audio source signals directly from audio source 160. In such instances, spatial computation application 116 may process the audio source signal(s) to generate the sound parameters and/or speakers signals that are to be transmitted to the speakers included in speaker array 130. In some embodiments, spatial computation application 116 may generate sound parameters based on the locations and/or orientations of the speakers relative to each other and/or relative to a target location. The sound parameters may then be transmitted to the corresponding speakers. The digital signal processing unit (DSP) 135 included in each speaker may separately process the audio source signal received from audio source 160, and then generate and output a speaker signal based on the corresponding sound parameter(s) and the audio source signal in order to generate a desired acoustic field at the target location.

In some embodiments, spatial computation application 116 may modify the frequency characteristics associated with the sound outputted by one or more speakers. In various embodiments, spatial computation application 116 may select the subset of individual speakers to produce the modified speaker signals based on an intended audio effect (e.g., surround sound, bass boost, and so forth). For example, spatial computation application 116 could cause only a subset of individual speakers, such as a subset of speakers included in speaker array 130 closest to the target location, to emit soundwaves that correspond to high-frequency portions of the audio source signal. In such instances, spatial computation application 116 may filter an audio source signal included in the one or more speaker signals in order to isolate and/or remove low-frequency audio content. Speaker array 130 may then produce a composite acoustic field that has the filtered audio source signal.

For example, when modifying the speaker signal to emphasize the high-frequency portions, spatial computation application 116 can first generate a subset of speaker signals from the high-frequency portions of the audio source signal. Spatial computation application 116 can then transmit this subset of speaker signals to a specified subset of individual speakers included in speaker array 130. In another example, spatial computation application 116 may compensate for phase delays between individual speakers due to the current configuration of speaker array 130. In such instances, spatial computation application 116 may determine sound parameters that include a phase delay between individual speakers. Spatial computation application 116 may then generate modified speaker signals that compensate for individual soundwaves emitted by different individual speakers reaching the target location at different times.

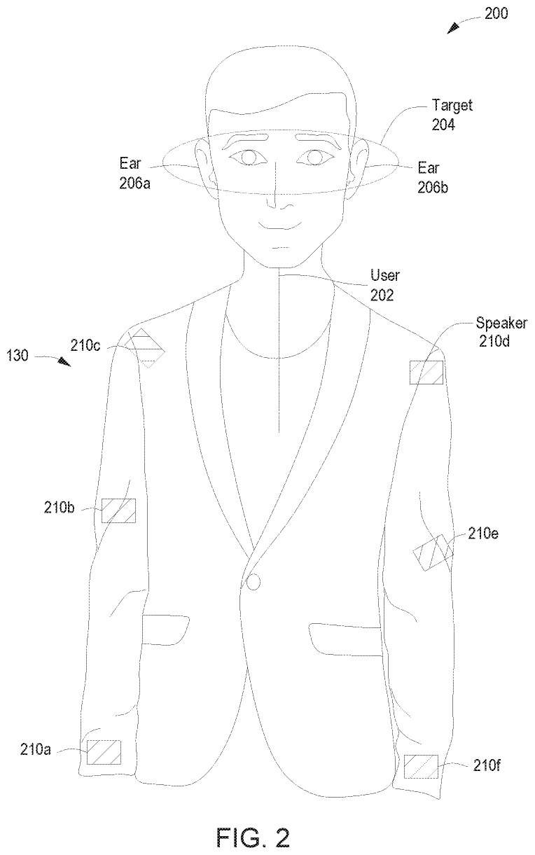

FIG. 2 illustrates the beamforming speaker array system 150 of FIG. 1A in a wearable device form factor 200, according to various embodiments of the present disclosure. Wearable device form factor 200 is worn by a user 202 with a target 204 being located proximate to the user's head. In some embodiments, target 204 may include the user's ears 206a-b. Wearable form factor 200 includes speaker array 130, which has multiple individual speakers 210a-f attached to the body of user 202 in different positions.

Speakers 210a-f are individual speakers included in speaker array 130. Speakers 210a-f may be loudspeakers that include one or more audio transducers that are configured to emit soundwaves based at least on one or more speaker signals received from spatial computation application 116. As the plurality of soundwaves from speakers 210a-f propagate towards target 204, the acoustic fields produced by soundwaves interfere with each other constructively and destructively to combine and produce a composite acoustic field.

In some embodiments, each speaker 210a-f may receive a separate speaker signal that includes a different modified audio source signal from a set of modified audio source signals. Each of the different modified audio source signals may incorporate different characteristics associated with the audio source signal, such as a specified frequency. Each of speakers 210a-f may be configured to reproduce one of the different modified audio source signals by emitting a soundwave based on a received speaker signal that includes the modified audio source signal.

In some embodiments, one or more of speakers 210a-f included in speaker array 130 may be positioned on the body of user 202 through an attachment device, or attached to clothing (e.g., a jacket, shirt, sweatshirt, etc.) that user 202 wears. For example, speakers 210a-f may be sewn into the arms of the clothing of user 202, be attached via adhesive, and/or be mechanically attached via an attachment mechanism. In some embodiments, one or more of speakers 210a-f include sensor(s) 120 that produce sensor data.

Spatial computation application 116 analyzes sensor data to determine the current configuration of speaker array 130, including the position(s) and/or orientation(s) for each speaker 210a-f. The current configuration of speaker array 130 includes a specific configuration of each speaker 210a-f. In some embodiments, the specific configuration of an individual speaker 210a includes one or more of an absolute position of the individual speaker 210a within the environment, a position of individual speaker 210a to relative other individual speakers 210b-f, and/or a position of individual speaker 210a to relative target 204 and/or other devices like computing device 110 and/or audio source 160. In some embodiments, the specific configuration of an individual speaker 210a includes an absolute angular orientation of one or more audio transducers included in individual speaker 210a based on one or more axes within the environment, and/or an angular orientation of the one or more audio transducers relative to another location or device within the environment, such as target 204.

Speaker array 130 is configured to emit soundwaves from at least one or more of speakers 210a-f in order to produce a composite acoustic field at target 204. In some embodiments, each speaker 210a-f included in speaker array 130 emits a separate soundwave. Each of the soundwaves generates a specific acoustic field, where the acoustic fields interfere with each other constructively and destructively to produce a composite acoustic field. Speaker array 130 may be configured to produce a composite acoustic field that is large enough to encompass all of target 204.

In some embodiments, speaker array 130 continues to produce a composite acoustic field proximate to target 204, even as the configuration of speaker array 130 changes from the current configuration to a different configuration. For example, the current configuration of speaker array 130 may change due to one or more of speakers 210a-f changing position(s) and/or orientation(s). The change in position(s) and/or orientation(s) may be due, for example, to a movement made by user 202. In some embodiments, speaker array 130 may be configured to produce multiple composite acoustic fields simultaneously, where a first set of speakers 210a-c included in speaker array 130 produces a first composite acoustic field that encompasses ear 206a, and a second set of speakers 210d-f included in speaker array 130 produces a second composite acoustic field that encompasses ear 206b.

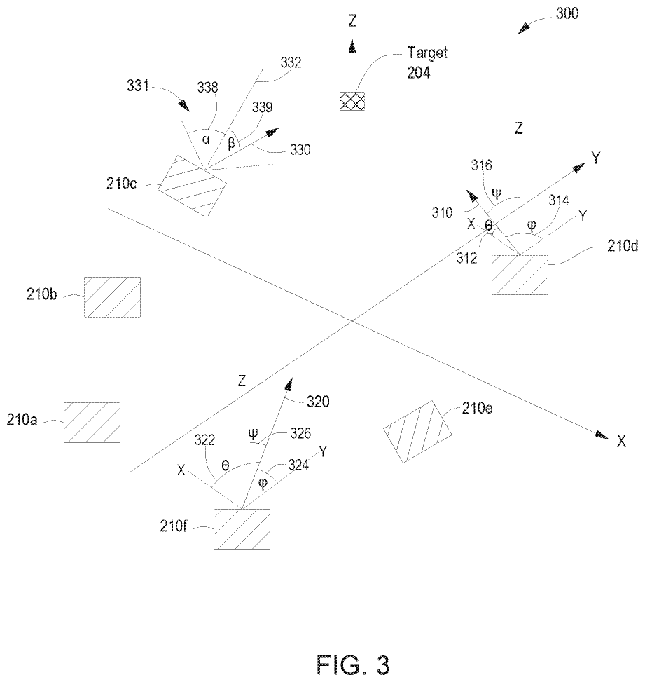

FIG. 3 illustrates a configuration 300 of the beamforming speaker array system 100 of FIG. 1A and directional sound components 310, 320, 330 emitted by the speakers 210a-f towards a target 204, according to various embodiments of the present disclosure. Configuration 300 illustrates the positions of speakers 210a-f of speaker array 130 within a three-dimensional space of the environment that includes target 204. In some embodiments, one or more speakers 210a-f may be configured emit soundwaves towards target 204.

Spatial computation application 116 analyzes sensor data received from sensor(s) 120 and determines configuration 300 of speakers 210a-f. In some embodiments, spatial computation application 116 determines specific configurations for individual speakers 210a-f included in configuration 300, as well as spatial relationships between one or more individual speakers 210a-f and other speakers 210a-f, computing device 110, sensor(s) 120, audio source 160, and/or target 204.

In some embodiments, the specific configuration of an individual speaker 210d includes information associated with the absolute position and/or absolute orientation of the individual speaker 210d within the environment. For example, spatial computation application 116 may determine the absolute position of speaker 210d within the environment and store the absolute position as a set of {x, y, z} coordinates. Similarly, spatial computation application 116 may determine the absolute orientation of an audio transducer included in speaker and store the absolute orientation as a set of angles {θ₀, φ₀, ψ₀} relative to the x-axis, y-axis, and z-axis specified within the environment, respectively. In various embodiments, the specific configuration of an individual speaker 210d includes information associated with the position(s) of the individual speaker 210d relative to other devices and/or locations within the environment. For example, spatial computation application 116 may determine the position of speaker 210d as a set of scalar and/or vector distances relative to target 204, relative to other individual speakers 210a-c, 210e-f, relative to sensor(s) 120, relative to audio source 160, and/or relative to computing device 110.

Based on the configuration 300, spatial computation application 116 computes one or more directional sound components 310, 320, 330 for one or more speakers 210a-f included in speaker array 130. In some embodiments, multiple spatial computation applications 116 may compute one or more directional sound components 310, 320, 330 based on configuration 300. In such instances, each spatial computation application 116 may separately determine configuration 300 and separately determine at least one directional sound component.

During operation, spatial computation application 116 computes a directional sound component as a component of an acoustic field produced by a speaker 210a-f emitting a soundwave. The directional sound component includes one or more physical characteristics. The physical characteristics of the directional sound component define how a portion of a soundwave emitted from an individual speaker 210d propagates within the environment. In some embodiments, the characteristics of the directional sound component may be components of a vector, such as an amplitude and/or set of angles.

Spatial computation application 116 computes the directional sound components of one or more speakers based on one or more sound parameters of the acoustic field that is to be produced. When computing the directional sound components, spatial computation application 116 determines sound parameters associated with the sound that is to be emitted by speakers 210a-f. In such instances, spatial computation application 116 may execute at least one algorithm to compute the directional sound components that are to be produced by speakers 210a-f that optimize at least one parameter of the resultant acoustic field.

In some embodiments, spatial computation application 116 may control the intensity (as measured by pressure and volume velocity) of each directional sound component in order to control the parameters of the acoustic field. Similarly, spatial computation 116 may also control one or more phase delays between each directional sound component in order to control or optimize the resultant acoustic field.

For example, when optimizing the parameters of the acoustic field, spatial computation application 116 computes the sound parameters of the acoustic field such that the acoustic field includes a “bright zone” of high sound pressure, where the bright zone enables the user to hear the audio signal. In some embodiments, spatial computation application 116 optimizes the bright zone by computing the acoustic potential energy, which determines the magnitude of a sound perception. Optimizing the acoustic potential energy enables speaker array 130 to produce the largest magnitude of sound perception for a given input energy.

For example, spatial computation application 116 could determine the pressure levels of the acoustic field that is to be produced by performing a pressure mapping of the environment based on the soundwaves that speakers 210a-f are to emit. Spatial computation application 116 could then determine an acoustic potential energy, which determines the magnitude of a sound perception, by computing the pressure of a specific area within the environment (e.g., the bright zone) based on the positions of speakers 210a-f and the directional sound components 310, 320, 330 included in the soundwaves. In some embodiments, the pressure of a specific area is computed as a function of the position of each speaker position and the velocity of each soundwave.

In another example, spatial computation application 116 could determine an acoustic potential energy as a difference in energy relative to the environment. For example, spatial computation application 116 could control speakers 210a-f in order for the target acoustic field to have an energy difference (“acoustic contrast”) of at least 10 dB compared to the surrounding environment. In such instances, spatial computation application 116 could implement an acoustic contrast control (ACC) to cause the one or more directional sound components to produce an acoustic field that has a bright zone, with such a difference in acoustic potential energy relative to the environment. In some embodiments, spatial computation application 116 may compute directional sound components in order for speaker array 130 to emit soundwaves that produce an acoustic field that has characteristics corresponding to the acoustic contrast.

In some embodiments, spatial computation application 116 may compute the planarity of the acoustic field, which measures the extent to which the acoustic field within the bright zone resembles a plane wave. The planarity of the acoustic field may be computed based on the angle and energy levels of each soundwave upon reaching the bright zone. Spatial computation application 116 may optimize the energy included in the bright zone by optimizing the planarity of the acoustic field.

Spatial computation application 116 computes at least one directional sound component in speaker array 130. For example, spatial computation application 116 computes a directional sound component 310 for speaker 210d, which includes an amplitude corresponding to the intensity of the soundwave and multiple absolute angles relative to defined axes within the environment, such as first angle 312 (θ) relative to the x-axis, second angle 314 (φ) relative to the y-axis, and third angle 316 (ψ) relative to the z-axis. In another example, spatial computation application 116 computes a directional sound 320 for speaker 210f that has defined characteristics, including an amplitude, first angle 322 (θ), second angle 324 (φ), and third angle 326 (ψ).

In another example, spatial computation application 116 computes directional sound component 330 relative to center axis 332 of acoustic field 331 produced by speaker 210c. Spatial computation application 116 computes an inclination angle (β) 339 of directional sound component 330 relative to center axis 332. Spatial computation application 116 also computes coverage angle (α) 338 corresponding to the angle relative to the center axis 332, where the soundwave produced by speaker 210c is audible. In some embodiments, spatial computation application 116 may compare inclination angle 339 with coverage angle 338 to determine whether speaker 210c produces directional sound component 330 by emitting the soundwave that produces acoustic field 331. When speaker 210c would not produce directional sound component 330, spatial computation application 116 may generate one or more sound parameters that causes speaker 210c not to emit a soundwave.

Spatial computation application 116 generates speaker signals that cause speakers 210a-f to emit soundwaves that include the computed directional sound components 310, 320, 330. For example, spatial computation application 116 generates one or more sound parameters for speaker 210d corresponding to directional sound component 310, 320, 330. When speaker 210a-f receives a speaker signal that is generated from the one or more sound parameters, speaker 210a-f emits a soundwave that produces an acoustic field includes at least directional sound component 310, 320, 330.

In some embodiments, when speaker 210a-f cannot produce an acoustic field that includes directional sound component 310, 320, 330, spatial computation application 116 may generate a speaker signal that prevents speaker 210a-f from emitting a soundwave. For example, when the audio transducer of speaker 210a-f has an orientation that is opposite to the characteristic angles {θ, φ, ψ, α, β} 312, 314, 316, 338, 339 of directional sound components 310, 320, 330, spatial computation application 116 may generate sounds parameter(s) and/or speaker signal that causes speaker 210a-f to not emit a soundwave.

In some embodiments, speaker 210f may be configured to emit a soundwave with a higher intensity (in pressure and/or velocity) than a soundwave emitted by speaker 210c, 210d. Speaker 210f may emit a soundwave with a higher intensity because speaker 210f is positioned further away from target 204 than speaker 210c, 210d. In such instances, directional sound component 320 may have a higher intensity than directional sound components 310, 330.

In some embodiments, speakers 210c, 210d, 210f may emit soundwave simultaneously, where the soundwave emitted by speaker 210f reaches target 204 at a later time than the soundwave emitted by speakers 210c, 210d. In such instances, spatial computation application 116 may compensate for the delay of the soundwave emitted by speaker 210f reaching target 204. For example, spatial computation application 116 may incorporate a transducer phase delay into the one or more sound parameters for one or more of speakers 210a-f. In various embodiments, spatial computation application 116 may incorporate the transducer phase delay the speaker signal generated from the one or more sound parameters and transmit the speaker signal to a specified speaker 210d. The specified speaker 210d may then emit a soundwave that includes the transducer phase delay. In other embodiments, spatial computation application 116 may delay transmission of one of the speaker signals for a time specified by the transducer phase delay. Because one or more speakers 210a-f incorporate the transducer phase delay, speakers 210a-f emit soundwaves that reach target 204 simultaneously or a within a threshold time period.

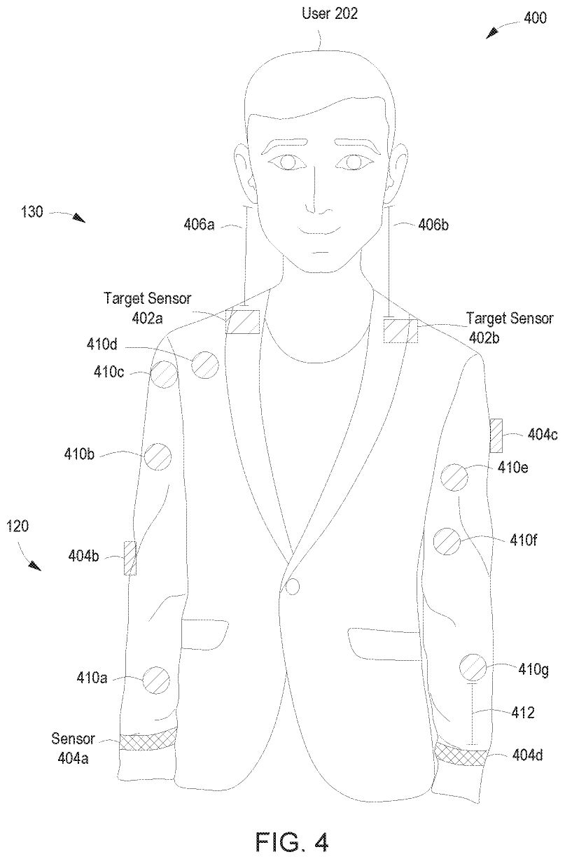

FIG. 4 illustrates the beamforming speaker array system of FIG. 1A in a wearable device form factor that includes position sensors, according to various embodiments of the present disclosure. Wearable form factor 200 includes a user 202 wearing clothing, where speaker array 130, including multiple individual speakers 410a-g, is attached to user 202 and/or attached to the clothing of user 202. Multiple position sensors 120, including target sensors 402a-b and sensors 404a-d, are also attached to user 202 and/or attached to the clothing of user 202.

In some embodiments, sensors 120 include multiple sensors 402a-b, 404a-d. In various embodiments, one or more sensors 402a-b, 404a-d included in the sensors 120 may be associated with a specific device and/or a specific location. For example, each of target sensors 402a-b may be associated with a specific target location (e.g., an ear of user 202). In such instances, target sensors 402a-b may produce sensor data for a location within the environment. Spatial computation application 116 may analyze the produced sensor data and, by applying the known relationship between target sensors 402a-b and the associated target location, may track the target location based on the produced sensor data. For example, spatial computation application 116 may store specific distance 406a between target sensor 402a and the ear of user 202 as a known relationship. Spatial computation application 116 may store specific distance 406b between target sensor 402b and the other ear of user 202 as a different known relationship. Spatial computation application 116 similarly stores a known distance 412 between sensor 410g and sensor 404d. Spatial computation application 116 may analyze the produced sensor data from target sensor 402a and may then apply specific distance 406a to the analyzed sensor data in order to estimate the position of the ear of user 202.

In some embodiments, one or more of sensors 404a-d may produce sensor data at specific locations on the body of the user. Spatial computation application 116 may analyze the produced sensor data and apply known relationships between individual sensors 404a-d and/or known relationships between individual sensors 404a-d and individual speakers 410a-g in order to determine the current configuration of speaker array 130. For example, sensors 404a, 404d are attached to the wrists, sensor 404b is attached to the elbow, and sensor 404c is attached to the upper arm of user 202. Spatial computation application 116 may analyze the produced sensor data to determine the positon of each sensor 404a-d. After determining the position of each sensor 404a-d, spatial computation application 116 may apply known relationships between sensors 404a-d and speakers 410a-g, such as distance 412, and determine the configuration of speaker array 130. In some embodiments, spatial computation application 116 may incorporate a known skeletal model of the user to determine the position of user 202 and/or speakers 410a-g positioned on the body of the user based on the produced sensor data.

Speaker array 130 includes speakers 410a-g attached to user 202 at various locations of the body of the user. For example, speakers 410a-c are attached to one arm of the user, speakers 410e-f are attached to another arm of the user, and speaker 410d is attached to the chest of the user. In some embodiments, spatial computation application 116 may determine one or more distances between a sensor 404a-d and one or more speakers 410a-g and store the one or more distances as known relationship(s). Spatial computation application 116 may determine the current configuration of speakers 410a-g based on the produced sensor data and the known relationship(s) between sensors 404a-d and speakers 410a-g.

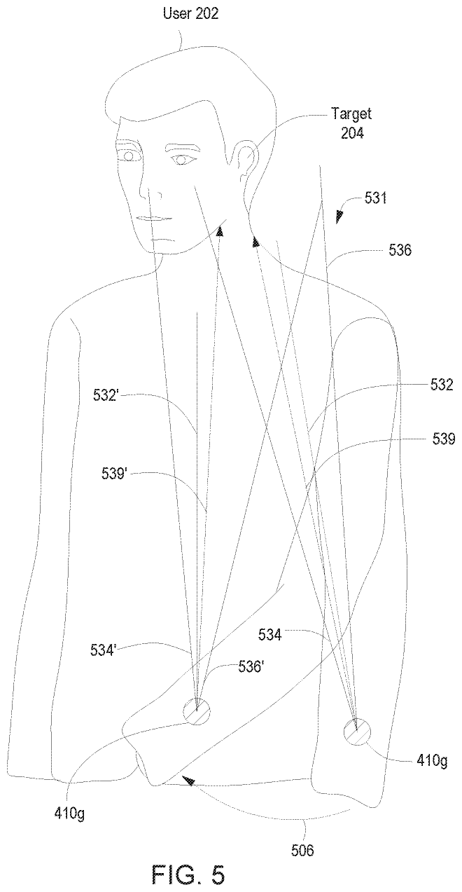

FIG. 5 illustrates a speaker included in the beamforming speaker array system of FIG. 1A emitting soundwaves at different positions, according to various embodiments of the present disclosure. As illustrated, speaker 410g initially produces acoustic field 531, defined by edges 534, 536 that encompasses target 204. When user 202 performs movement 506, speaker 410g produces acoustic field 531 from a different position, defined by edges 534′, 536′.

In some embodiments, speaker 410g emits a soundwave with physical characteristics specified by a received speaker signal. The soundwave produces acoustic field 531, which includes center axis 532 and edges 534, 536. Outside of edges 534, 536 the soundwave produced by speaker 410g may not be audible. In some embodiments, spatial computation application 116 determines whether the directional sound component 539 is included within acoustic field 531. When spatial computation application 116 determines that the directional sound component is included within acoustic field 531, spatial computation application 116 may generate one or more sound parameters. The speaker signal generated from the one or more sound parameters causes speaker 410g to emit acoustic field 531.

When user 202 performs arm movement 506, speaker 410g is in a new position and/or orientation relative to target 204. In some embodiments, spatial computation application 116 may determine whether the directional sound component 539′ is included within the updated acoustic field 531′ and, if so, spatial computation application 116 may generate an updated speaker signal. The updated speaker signal may cause speaker 410g to produce directional sound component 539′ that has updated center axis 532′ and updated edges 534′, 536′. In some embodiments, spatial computation application 116 may determine that no updates to the speaker signal are necessary because target 204 remains within the area encompassed by acoustic field 531′. In such instances, spatial computation application 116 may not generate an updated speaker signal. Instead, spatial computation application 116 may transmit an unmodified speaker signal to speaker 410g, which produces acoustic field 531′ at the new position.

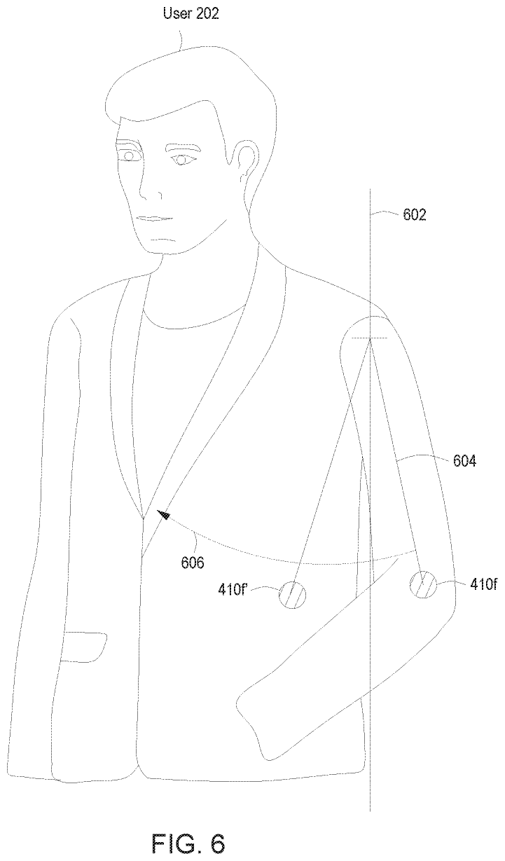

FIG. 6 illustrates a predictive estimation of a position of a speaker included in the beamforming speaker array system of FIG. 1A as a user moves, according to various embodiments of the present disclosure. As illustrated, speaker 410f changes positions to new position 410f due to a movement 606 performed by user 202. For example, user 202 may perform movement 606 as a repetitive motion during a routine, such as when running. Spatial computation application 116 may perform one or more predictive estimation to estimate the future position 410f′ of speaker 410f based on movement 606.

In some embodiments, spatial computation application 116 may analyze one or more previous positions of speaker 410f to estimate one or more future positons 410f′ of speaker 410f For example, user 202 may perform a movement 606 of swinging an upper arm while keeping the shoulder fixed. In such instances, spatial computation application 116 may model the movement of speaker 410g as a sinusoidal, simple harmonic arm movement. In some embodiments, spatial computation application 116 may determine a specified distance 604 between speaker 410g and a point on the shoulder of user 202. Spatial computation application 116 may also determine an angle formed by specified distance 604 relative to axis 602 of the user's shoulder.

Spatial computation 116 incorporates the specified distance and the modeled harmonic movement in order to predict the future location 410f′ before movement 606 causes speaker 410f to reach the future location 410f. In various embodiments, spatial computation application 116 may generate one or more sound parameters, audio source signals, and/or speaker signals for speaker 410f based on the predicted future location 410f′ of speaker 410f. In such instances, spatial computation application 116 may send the speaker signals to speaker 410f before reaching the new position 410f. In such instances, speaker 410f emits soundwaves based on the predicted position 410f, resulting in beamforming speaker array system 150 responding faster to a change in position.

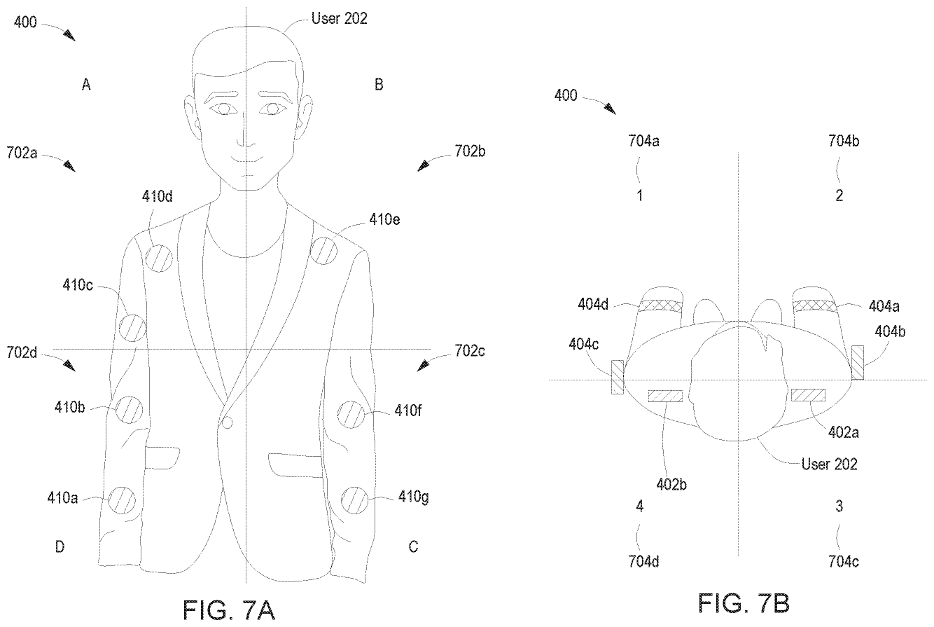

FIGS. 7A-7B illustrate a different technique to estimate the position of an individual speaker included in the beamforming speaker array system of FIG. 1B, according to various embodiments of the present disclosure FIG. 7A illustrates wearable device form factor 400, including speakers 410a-g of speaker array 130. In some embodiments, spatial computation application 116 may produce sensor data and determine the positions of speakers 410a-g. In lieu of determining a precise position and/or orientation of speakers 410a-g, spatial computation application 116 may simplify the determination of the positions of speakers 410a-g by determining a low-resolution position of speakers 410. For example, spatial computation application 116 may only determine the quadrant of the environment in which the speakers 410a-g are located.

For example, spatial computation application 116 may determine that speakers 410c-d are located in quadrant 702a (“quadrant A”), speaker 410e is located in quadrant 702b (“quadrant B”), speakers 410f-g are located in quadrant 702c (“quadrant C”), and speakers 410a-b are located in quadrant 702d (“quadrant D”). Spatial computation application 116 may compute the directional sound components for speakers 410a-g based on the quadrant in which the speaker is located.

FIG. 7B illustrates wearable device form factor 400, including sensors 402a-b, 404a-d of sensor(s) 120. In some embodiments, spatial computation application 116 may acquire low-resolution sensor data that indicates one or more quadrants in which the sensor is located. The quadrants used for the low-resolution sensor data may be different from the quadrants used for the low-resolution positions of speakers 410a-g. For example, sensors 402a-b, 404a-d acquire low-resolution sensor data indicating that sensors 404c-d are located in quadrant 704a (“quadrant 1”), sensors 404a-b are located in quadrant 704b (“quadrant 2”), sensor 402a is located in quadrant 704c (“quadrant 3”), and sensor 402b is located in quadrant 702d (“quadrant 4”). Spatial computation application 116 may determine the configuration of speaker array 130 by based on the low-resolution sensor data acquired by sensors 402a-b, 404a-d.

In some embodiments, low-resolution sensor data and/or the low-resolution position of speakers 410a-g allows spatial computation application 116 to compute approximate directional sound components for speakers 410a-g faster than other computational methods that determine more precise positions and/or orientations of speakers 410a-g when determining the current configuration. In some embodiments, spatial computation application 116 generates speaker signals from the approximate directional sound components. The speaker signals cause speakers 410a-g to produce the composite acoustic field at target 204, even though the estimated current configuration of speaker array 130 made by spatial computation application 116 is not as precise.

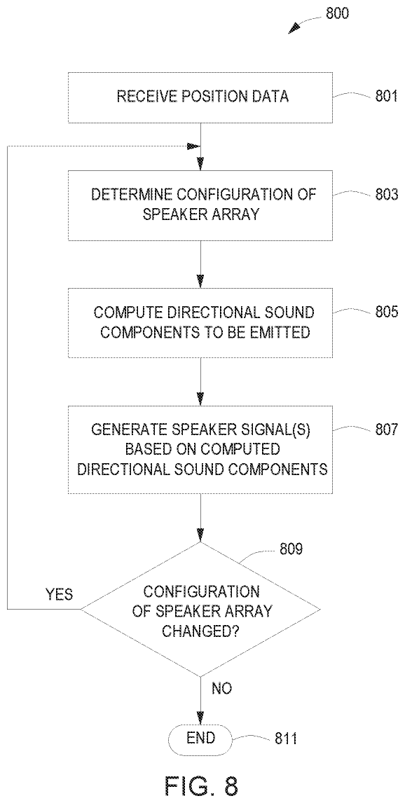

FIG. 8 is a flow diagram of method steps for generating speaker signals to emit directional sounds, according to various embodiments of the present disclosure. Although the method steps are described in conjunction with the systems of FIGS. 1-7B, persons skilled in the art will understand that any system configured to perform the method steps, in any order, falls within the scope of the present disclosure.

Method 800 begins at step 801, where sensor(s) 120 receive position data. In some embodiments, sensor(s) 120 may include one or more target sensors 402a-b that produce sensor data related to the position of a target 204. In some embodiments, sensor(s) 120 include one or more sensors 404a-d that produce sensor data related to the positions and/or the orientations of speakers 410a-g included in speaker array 130.

At step 803, computing device 110 determines a configuration of speaker array 130. In some embodiments, spatial computation application 116 analyzes sensor data received from sensor(s) 120 and determines a current configuration of speaker array 130 based on the sensor data. The configuration of speaker array 130 includes the specific configurations of each of the individual speakers 410a-g included in speaker array 130. In some embodiments, two or more spatial computation applications 116 may separately and independently receive sensor data from sensor(s) 120 and determine the current configuration of speaker array 130.

At step 805, computing device 110 computes directional sound components 310, 320 to be emitted. In some embodiments, spatial computation application 116 analyzes the current configuration 300 of speaker array 130 and computes a set of directional sound components 310, 320 to be emitted by individual speakers 410a-g included in speaker array 130. In some embodiments, spatial computation application 116 computes the set of directional sound components based on the position(s) and/or orientation(s) of speakers 410a-g in the current configuration 300.

At step 807, computing device 110 generates speaker signal(s) based on the computed directional sound components. In some embodiments, spatial computation application 116 may generate one or more sound parameters based on the set of computed directional sound components. The one or more sound parameters may be used to generate a speaker signal included in a set of speaker signals that computing device 110 transmits to speaker array 130. In such instances, computing device 110 may transmit at least one speaker signal included in the set of speaker signals to each of the individual speakers included in speaker array 130. The set of speaker signals may incorporate different amplitudes and/or different transducer phase delays based on the computed directional sound components.

In some embodiments, a separate spatial computation application 116 may be executed to coordinate the operation of each individual speaker 410a-g included in speaker array 130. In such instances, each spatial computation application 116 may generate and transmit a single speaker signal for the corresponding speaker 410a-g. Speaker array 130 may emit soundwaves based on the set of speaker signals, where the soundwaves combine to produce a composite acoustic field at target 204. In some embodiments, after generating the speaker signal(s), computing device 110 may return to step 801 to receive position data, instead of proceeding to step 809. In such embodiments, computing device may optionally repeat steps 801-807 while computing device is playing the audio signal.

At step 809, computing device 110 may determine whether the configuration of speaker array 130 has changed. In some embodiments, spatial computation application 116 may determine whether the position(s) and/or orientation(s) of one or more individual speakers included in speaker array 130 has changed after the spatial computation application 116 determined the current configuration of speaker array 130. In some embodiments, the sensor(s) 120 receive additional position data before spatial computation application 116 makes the determination. If spatial computation application 116 determines that the configuration of speaker array 130 has changed, computing device 110 returns to step 803. Otherwise, if spatial computation application 116 determines that the configuration of speaker array 130 has not changed, computing device 110 ends method 800 at step 811.

In sum, one or more sensors included in a beamforming speaker array system produce sensor data that is associated with a target location and/or with other speaker(s) included in the speaker array. A spatial computation application included in the beamforming speaker array system dynamically determines a current configuration of the speaker array based on the sensor data. The current configuration of the speaker array may include the position and/or orientation of each individual speaker included in the speaker array. The spatial computation application computes directional sound components of soundwaves to be emitted by the speaker array based on positions and/or orientations of the individual speakers included in the determined configuration of the speaker array. The spatial computation application then generates a set of speaker signals for the speaker array based on the directional sound components. The spatial computation application transmits one of the speaker signals in the set of speaker signals to each speaker included in the speaker array. In some embodiments, separate spatial computation applications, each of which is coupled to an individual speaker included in the speaker array, generate a speaker signal for the individual speakers and transmit the corresponding speaker signal to the individual speaker.

Each speaker included in the speaker array emits a soundwave based on the speaker signal received from the set of speaker signals. The emitted soundwave produces an acoustic field that includes the directional sound component specified in a one or more sound parameters used to generate the speaker signal. The soundwaves emitted from each of the speakers may be highly directional and constructively and/or destructively combine with other acoustic fields produced from the other speakers included in the speaker array to form a composite acoustic field. The soundwaves included in the composite acoustic field cause the user of the beamforming speaker array system to hear audio content corresponding to the audio source signal. In various embodiments, the spatial computation application continually updates the determined current configuration of the speaker array based on the changing position(s) and/or orientations of one or more individual speakers included in the speaker array. The spatial computation application generates updated speaker signals and transmits the updated speaker signals to the speakers so that the speakers produce a constant composite acoustic field surrounding the user's ears.

At least one advantage of the disclosed techniques is that audio signals can be transmitted to a user's ears without requiring mechanical headphones that obstruct other audio signals from the surrounding environment. In addition, because the beamforming speaker array continually generates new parameterized signals based on the relative positions of each of the individual speakers, the speaker array does not require a rigid spatial relationship to produce a consistent acoustic field.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

1. An audio system, comprising:
a speaker array comprising two or more speakers, wherein a configuration of the speaker array changes when at least one of the two or more speakers moves in correspondence with a movement of an object;
one or more sensors configured to produce sensor data associated with the configuration of the speaker array; and
a processor coupled to the one or more sensors and the speaker array and configured to:
determine, based on the sensor data, for each speaker included in the speaker array, a position of the speaker relative to a target location
determine, based on the sensor data, for each speaker included in the speaker array, a position of the speaker relative to other speakers included in the speaker array,
determine, based on the positions of each speaker included in the speaker array relative to the target location and on the positions of each speaker included in the speaker array relative to the other speakers included in the speaker array, a first set of directional sound components, wherein each directional sound component included in the first set of directional sound components is defined between a corresponding speaker and the target location, and
generate a first set of speaker signals for the speaker array based on the first set of directional sound components, wherein, when outputted by the speaker array, the first set of speaker signals produces an acoustic field at the target location.

2. The audio system of claim 1, wherein the one or more sensors includes a plurality of sensors, wherein each sensor included in the plurality of sensors detects at least one of:
a location of a different speaker included in the speaker array; or an orientation of a different speaker included in the speaker array.

3. The audio system of claim 1, wherein the processor is further configured to:
receive, from an audio source, an audio source signal to be outputted via the speaker array,
wherein generating the first set of speaker signals comprises modifying, based on the first set of directional sound components, at least one of:
a phase of the audio source signal, or
an intensity of the audio source signal.

4. The audio system of claim 3, wherein modifying the at least one of the phase or the intensity of the audio source signal comprises modifying a first phase of at least a portion of the audio source signal based on a distance between a first speaker included in the speaker array and the target location.

5. The audio system of claim 3, wherein modifying the at least one of the phase or the intensity of the audio source signal comprises modifying a first intensity of at least a portion of the audio source signal based on an orientation of a center axis of a first speaker included in the speaker array relative to the target location.

6. The audio system of claim 1, wherein the processor is further configured to:
determine, based on additional sensor data, for each speaker included in the speaker array, a second position of the speaker,
determine, based on the second positions of the speakers, a second set of directional sound components, wherein each directional sound component included in the second set of directional sound components is defined between the corresponding speaker and the target location, and
generate a second set of speaker signals for the speaker array based on the second set of directional sound components, wherein, when outputted by the speaker array, the second set of speaker signals produces a second acoustic field at the target location.

7. The audio system of claim 6, wherein the processor is configured to determine the second positions of the speakers based at least on a predictive estimation of a first speaker included in the speaker array.

8. The audio system of claim 7, wherein the predictive estimation of the first speaker is based at least on a model of a skeleton of a user.

9. The audio system of claim 1, wherein the one or more sensors includes a target sensor, and wherein the processor is further configured to determine the target location based on the sensor data acquired from the target sensor.

10. The audio system of claim 9, wherein a first speaker of the speaker array generates a first acoustic field based on a first speaker signal included in the first set of speaker signals, a second speaker of the speaker array generates a second acoustic field based on a second speaker signal included in the first set of speaker signals, and the first acoustic field constructively combines with the second acoustic field to produce a composite acoustic field at the target location.

11. A computer-implemented method, comprising:
determining, based on sensor data associated with a configuration of a speaker array and acquired from one or more sensors, for each speaker included in the speaker array, a first position of the speaker relative to a target location;
determine, based on the sensor data, for each speaker included in the speaker array, a second position of the speaker relative to other speakers included in the speaker array, wherein the configuration of the speaker array changes when at least one speaker included in the speaker array moves in correspondence with a movement of an object;
determining, based on at least the first position of a first speaker included in the speaker array relative to the target location and on the second position of the first speaker relative to the other speakers included in the speaker array, a first speaker directional sound component defined between the first speaker and the target location; and
generating, for the first speaker, a first speaker signal based on the first speaker directional sound component, wherein, when outputted by the first speaker, the first speaker signal produces a portion of an acoustic field at the target location.

12. The computer-implemented method of claim 11, further comprising:
determining, based on at least the first position of a second speaker in the speaker array, a second speaker directional sound component defined between the second speaker and the target location; and
generating, for the second speaker, a second speaker signal based on the second speaker directional sound component, wherein, when outputted by the second speaker, the second speaker produces a second portion of the acoustic field at the target location.

13. The computer-implemented method of claim 12, further comprising determining a first phase delay between the first speaker signal and the second speaker signal, wherein the first phase delay is based on a difference between a first distance of the first speaker relative to the target location and a second distance of the second speaker relative to the target location.

14. The computer-implemented method of claim 11, further comprising:
determining, based on additional sensor data, for each speaker included in the speaker array, a third position of the speaker relative to the target location;
determining, based on at least the third position of the first speaker, an updated first speaker directional sound component defined between the first speaker and the target location, and
generating, for the first speaker, an updated first speaker signal based on the updated first speaker directional sound component, wherein, when outputted by the first speaker, the updated first speaker signal produces a portion of an updated acoustic field at the target location.

15. The computer-implemented method of claim 11, further comprising:
receiving, from an audio source, an audio source signal to be outputted via the speaker array,
wherein generating the first speaker signal comprises modifying, based on the first speaker directional sound component, at least one of:
a phase of the audio source signal, or
an intensity of the audio source signal.

16. The computer-implemented method of claim 15, wherein modifying at least one of the phase or the intensity of the audio source signal comprises modifying at least one of:
a first phase of at least a portion of the audio source signal based on a distance between the first speaker and the target location; or
a first intensity of at least a portion of the audio source signal based on an orientation of a center axis of the first speaker relative to the target location.

17. One or more non-transitory computer-readable media for storing program instructions that, when executed by a processor, causes the processor to perform steps of:
determining, based on sensor data associated with a configuration of a speaker array and acquired from one or more sensors, a position for each speaker included in the speaker array;
determine, based on the sensor data, a position for each speaker included in the speaker array relative to other speakers included in the speaker array, wherein the configuration of the speaker array changes when at least one speaker included in the speaker array moves in correspondence with a movement of an object;
determining, based on the positions of the speakers included in the speaker array relative to the target location and on the positions of the speakers included in the speaker array relative to the other speakers included in the speaker array, a first set of directional sound components, wherein each directional sound component included in the first set of directional sound components is defined between a corresponding speaker and the target location; and
generating a first set of speaker signals for the speaker array based on the first set of directional sound components, wherein, when outputted by the speaker array, the first set of speaker signals produces an acoustic field at the target location.

18. The one or more non-transitory computer-readable media of claim 17, further comprising instructions that, when executed by the processor, causes the processor to perform steps of:
determining, based on additional sensor data acquired, for each speaker included in the speaker array, a second position of the speaker;
determining, based on the second positions of the speakers, a second set of directional sound components, wherein each directional sound component included in the second set of directional sound components is defined between the corresponding speaker and the target location; and
generating a second set of speaker signals for the speaker array based on the second set of directional sound components, wherein a second speaker signal included in the second set of speaker signals is generated based on a phase delay that corresponds to a difference between (i) a third distance between a first speaker included in the speaker array and the target location and (ii) a fourth distance between a second speaker included in the speaker array and the target location.

19. The one or more non-transitory computer-readable media of claim 17, further comprising instructions that, when executed by the processor, causes the processor to perform steps of:
transmitting a first speaker signal to a first speaker; and
transmitting a second speaker signal to a second speaker.

20. The one or more non-transitory computer-readable media of claim 17, further comprising instructions that, when executed by the processor, causes the processor to perform steps of:
transmitting, to a first speaker, a first directional sound component included in the first set of directional sound components, wherein a processor included in the first speaker generates a first speaker signal; and
transmitting, to a second speaker, a second directional sound component included in the first set of directional sound components, wherein a processor included in the second speaker generates a second speaker signal.

21. The audio system of claim 1, wherein the processor is further configured to, prior to generating the first set of speaker signals, modify a frequency characteristic associated with a first directional sound component included in the first set of directional sound components.
